(19) United States
(12) Patent Application Publication
(10) Pub. No.: US 2007/0228803 A1
(43) Pub. Date: Oct. 4, 2007

(54) DUMP TRUCK

(76) Inventor: Charles Raup, Thomasboro, IL (US)

Correspondence Address: MICHAEL BERNS;MALONEY, PARKINSON AND BERNS, 135 W MAIN STREET, URBANA, IL, 61801, US

(21) Appl. No.: 11/694,573

(22) Filed: Mar. 30, 2007

Related U.S. Application Data
(60) Provisional application No. 60/744,012, filed on Mar. 30, 2006.

(51) Int. Cl. B60P 1/28

(52) U.S. Cl. 298/17 R

(57) ABSTRACT

This invention provides a dump truck suitable for working in off-road conditions. The truck tires are very wide and produce a large contact area to spread the wheel loads over a larger area. This reduces the wheel loads, thus reducing the wheel compression into the riding surface. The vehicle is thus able to travel in areas that other dump trucks can not travel, or could cause damage to the driving surface.

This application claims the priority of Provisional Application 60/744,012 filed on Mar. 30, 2006, which is hereby incorporated by reference in its entirety.

### SUMMARY OF THE INVENTION

This invention provides a dump truck suitable for working in off-road conditions. The truck tires are very wide and produce a large contact area to spread the wheel loads over a larger area. This reduces the wheel loads, thus reducing the wheel compression into the riding surface. The vehicle is thus able to travel in areas that other dump trucks can not travel, or could cause damage to the driving surface.

### DESCRIPTION OF THE DRAWINGS

FIG. 1 is an isometric view of an embodiment of the invention having three wheels.

FIG. 2 is a side view of the dump truck of FIG. 1.

FIG. 3 is a front view of the dump truck of FIG. 1-2.

FIG. 4 is a rear view of an embodiment of the invention.

FIG. 5 is a side view of the dump bed portion of an embodiment of the invention.

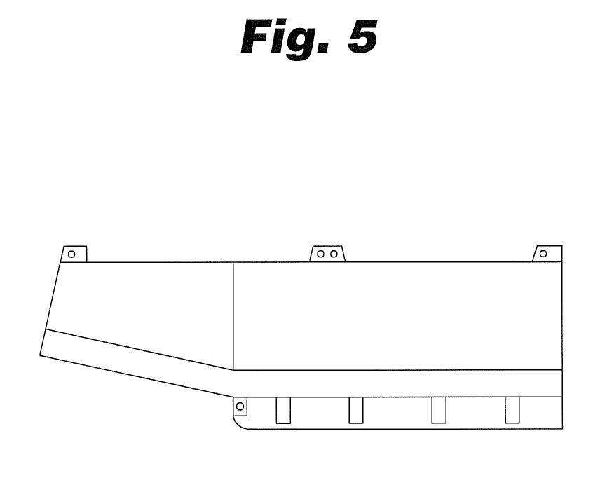

FIG. 6 is a rear view of the dump bed portion of the embodiment of FIG. 4.

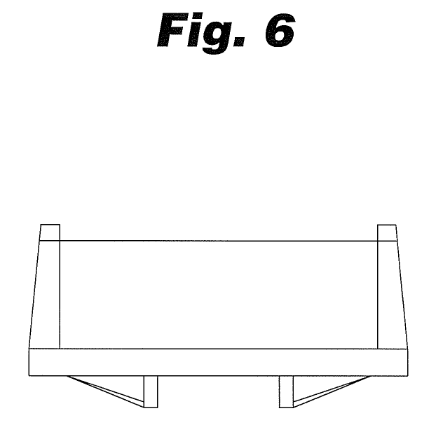

FIG. 7 is a side view of an extended embodiment of the invention having a removable trailer section.

### DETAILED DESCRIPTION OF THE INVENTION

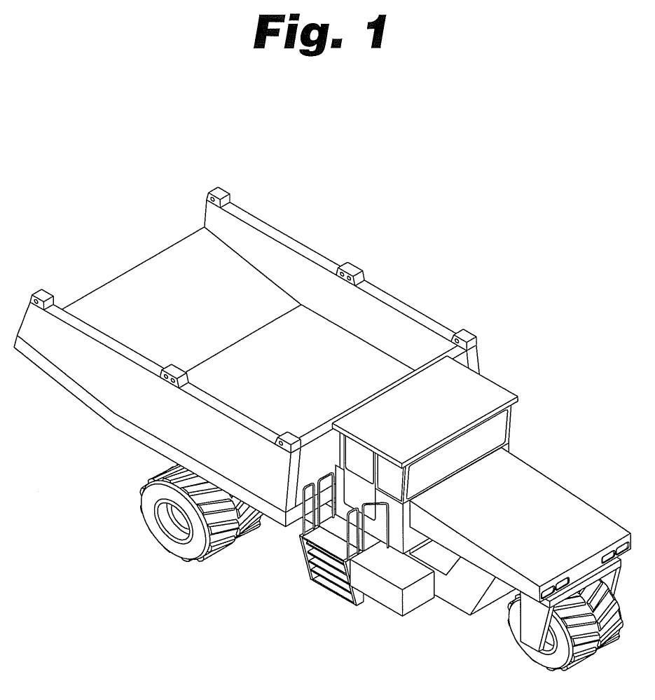

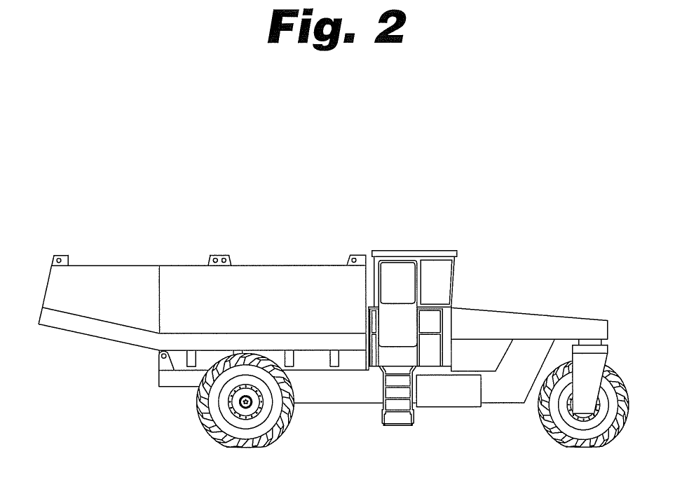

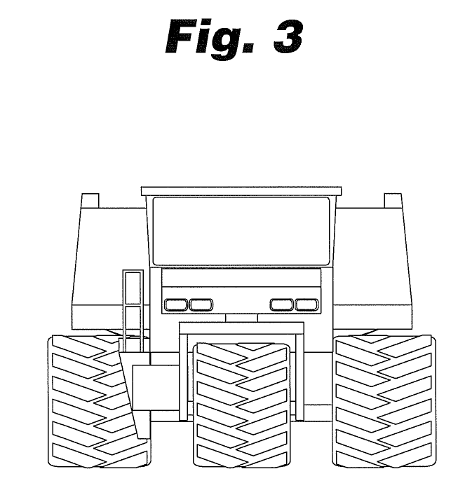

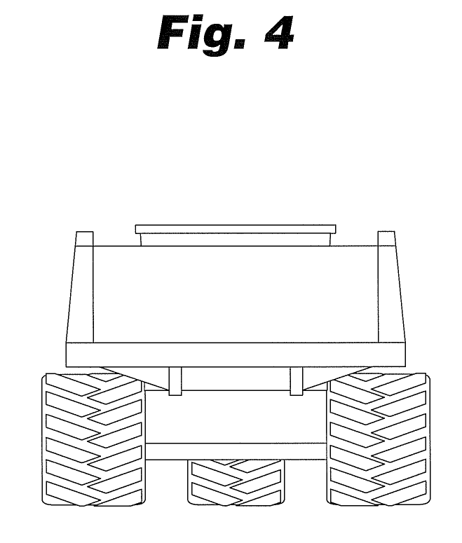

The embodiment shown in FIG. 1-4 may be created by building a new truck frame, or by modifying an existing truck frame for a self-powered sprayer unit with flotation tires. A Tyler Titan sprayer was modified to include the dump bed. The Tyler Titan sprayer was found to be an effective chassis for the design because of its large tires and high horsepower. Other sprayer chassis maybe suitable as a foundation for development of the invention, including the Case IH FLX3010, FLX3510, or FLX610. Models from the former Big A line of chassis are also found to be suitable.

On the prototype shown in the Figures, the frame was lowered approximately 14 inches. The frame was also modified to add cross bracing and supports for the additional loading. An Eaton or Eaton/Rockwell rear end has been found to be superior to other models. The ladders were needed to be moved from the back to the front or side in some models. This was needed because of the placement of the dump bed. The rear axle on the chassis was moved back to put more weight on the front wheels. This was shown to improve traction and floatation of the tires. It was also found to be beneficial to add air brakes to the dump truck to improve braking performance.

The flotation tires utilized should have a low tire pressure and wide tires. A flotation tire includes the Goodyear Super Terra Tire

Testing of the prototype was completed during levee rebuilding along the Gulf Coast after Hurricane Katrina. The U.S. Army Corps of Engineers was unable to find a suitable method of working on the levees due to the mud and high moisture levels. The present invention has proved to be successful in traveling along beaches and in muddy conditions. Wheel based trucks were unsuitable and track based excavators often required wooden mats to provide traction and flotation in the swampy conditions. Other trucks could not access the areas necessary. The flotation tires on the present invention, along with the dump bed were found to successfully perform the task.

Other locations may similarly need a work truck that has minimum tire compression and wheel loading. These may, without limitation, include muddy areas, beaches, golf courses, agricultural fields, athletic fields, swamps, sand, bogs, low-strength roads, or other soft or delicate riding surfaces. This is of particular benefit for environmentally sensitive areas.

A large dump bed with hydraulic dumping capabilities is provided in the invention. The dumping bed allows quick removal of dirt, debris, or other materials loaded into the device.

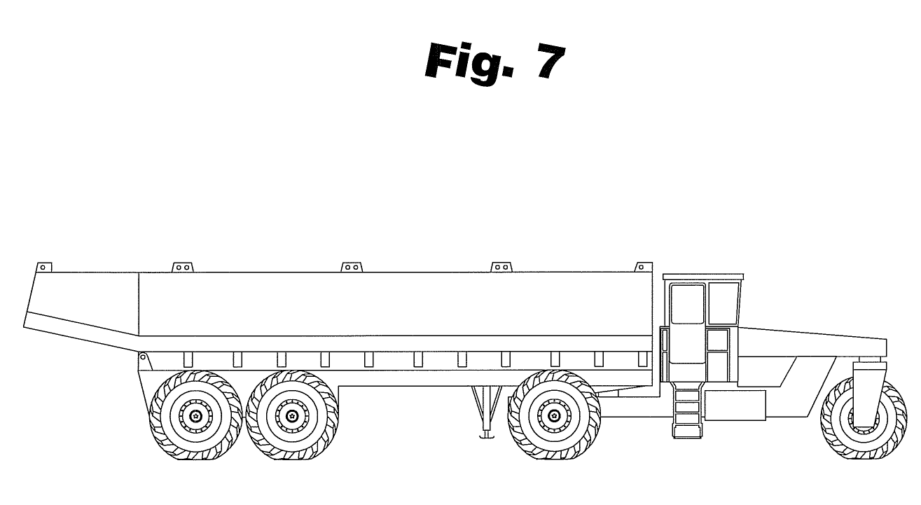

As shown in FIG. 7, a modified embodiment could provide a dump bed on a separate trailer. The dump bed and rear wheels may be detached from the front of the vehicle, as in a tractor-trailer truck. This could allow greater usage of multiple trailers for repairs, storage, and other functions.

I claim:

1. A vehicle movable over a wide range of terrain, comprising:
at least three wheels,
tires mounted on each of the at least three wheels comprising low-pressure, flotation tires,
a power source,
a dump bed for storing materials to be carried,
a cab for a user to operate the vehicle,
means for dumping the materials out of the dump bed,
wherein, the vehicle has a low impact on the

2. The vehicle according to claim 1, wherein the low-pressure, flotation tires are at least fifty inches wide.

3. The vehicle according to claim 1, wherein the vehicle may be separated into a truck portion and a trailer portion, wherein the dump bed and at least two wheels are provided in the trailer portion and the power source and cab are provided in the truck portion.
